(19) United States
(12) Patent Application Publication
(10) Pub. No.: US 2025/0083041 A1
(43) Pub. Date: Mar. 13, 2025

(54) GAME INTERACTION METHOD, COMPUTER DEVICE, STORAGE MEDIUM AND PROGRAM PRODUCT

(71) Applicant: SHANGHAI LILITH TECHNOLOGY CORPORATION, Shanghai (CN)

(72) Inventors: Jingjie WEI, Shanghai (CN); Yijiang NIU, Shanghai (CN)

(73) Assignee: SHANGHAI LILITH TECHNOLOGY CORPORATION, Shanghai (CN)

(21) Appl. No.: 18/557,907

(22) PCT Filed: Nov. 1, 2022
(86) PCT No.: PCT/CN2022/128896

§ 371 Date: Oct. 27, 2023

(51) Int. Cl. A63F 13/52; A63F 13/31

(52) U.S. Cl. CPC A63F 13/52; A63F 13/31

(57) ABSTRACT

The present disclosure relates to a game interaction method, a computer device, a storage medium, and a program product. The method includes: displaying a virtual scene on a client device, and displaying a role display interface in the virtual scene in response to a role display operation of a current user on the virtual scene; acquiring a role selection operation based on the role display interface, and determining a corresponding role virtual object as a target role in response to the role selection operation. One or more role virtual objects are displayed in the role display interface.

### CROSS-REFERENCE TO RELATED APPLICATIONS

The present disclosure is a national stage application of PCT international application No. PCT/CN2022/128896 filed on Nov. 1, 2022, and entitled “GAME INTERACTION METHOD, COMPUTER DEVICE, STORAGE MEDIUM AND PROGRAM PRODUCT”, the entire content of which is incorporated herein by reference.

### TECHNICAL FIELD

The present disclosure relates to the technical field of game design, and in particular, to a game interaction method, a computer device, a storage medium, and a program product.

### BACKGROUND

With the improvement of living standards, a variety of games have attracted much attention, especially emerging strong social games such as a decryption game, an escape room game, and a plot reasoning game. In these games, each player needs to be assigned a role at the beginning, and then the players perform the subsequent game processes according to the roles played.

The above-mentioned existing gameplays are mainly implemented in real-life scenarios.

### SUMMARY

In a first aspect, the present disclosure provides a game interaction method. The method includes a role display step and a role determination step. In the role display step, a virtual scene is displayed on a client device, and a role display interface is displayed in the virtual scene in response to a role display operation of a current user for the virtual scene. One or more role virtual objects are displayed in the role display interface. In the role determination step, a role selection operation is acquired based on the role display interface, and a corresponding role virtual object is determined as a target role in response to the role selection operation.

In an embodiment, before the role display step, the method further includes a role control display step. In the role control display step, a role control is displayed in the virtual scene in response to a first trigger operation on the virtual scene. The role display step includes the following step: the role display interface is displayed in the virtual scene in response to the role display operation on the role control in the virtual scene.

In an embodiment, in a case that one role virtual object and role information of the role virtual object are displayed in the role display interface, the method further includes the following step: another role virtual object and role information of the another role virtual object are displayed in the role display interface in response to a second trigger operation on the role display interface.

In an embodiment, the role display interface further includes a role control list, and the method further includes the following step: the role virtual object corresponding to the role control and the role information of the role virtual object corresponding to the role control are displayed in the role display interface in response to a third trigger operation on the role control in the role control list.

In an embodiment, in a case that a plurality of role virtual objects are displayed in the role display interface, the method further includes the following step: the role information of the role virtual object is displayed in the role display interface in response to a fourth trigger operation on the role virtual object.

In an embodiment, the method further includes the following steps: in a case that the role virtual object has been selected by another user, a prompt information is displayed in the role display interface. The prompt information is configured to indicate that the role virtual object has been selected. In a case that the role virtual object is selected by the current user, a deselection control is displayed in the role display interface. The deselection control is configured to deselect the role virtual object.

In an embodiment, the role display interface further includes a role state list. The role state list includes current states of all of the role virtual objects.

In an embodiment, the role state list includes a role identifier corresponding to each of the role virtual objects and a state bar corresponding to each of role identifier. The method further includes the following steps: user information of the role virtual object corresponding to each of the role identifier is acquired. The user information of the role virtual object corresponding to the role identifier is displayed in the state bar corresponding to the role identifier.

In an embodiment, the method further includes the following step: mark information corresponding to the role virtual object is displayed in the role state list.

In an embodiment, the role display interface further includes a user state list. The user state list includes the total number of users, the number of users who have selected the role virtual objects, and a role selection state of each of the users.

In an embodiment, the role display interface further includes a random selection control. The role determination step includes the following step: a role virtual object is randomly determined as the target role from all of unselected role virtual objects in response to a fifth trigger operation on the random selection control in the role display interface.

In an embodiment, the method further includes the following step: the random selection control is replaced with a cancel automatic assignment control after the random selection control is triggered. The cancel automatic assignment control is configured to deselect the target role.

In an embodiment, the randomly determining, in response to the fifth trigger operation on the random selection control in the role display interface, the role virtual object as the target role from all of the unselected role virtual objects includes the following step: the role virtual object is randomly determined as the target role from all of the unselected role virtual objects in response to the fifth trigger operation on the random selection control in the role display interface and when a preset time period is reached.

In an embodiment, the method further includes the following step: exits to the virtual scene when a preset exit condition is satisfied.

In an embodiment, the preset exit condition includes any one of the following: all of the users corresponding to the virtual scene have completed the role selection; a preset role selection time period is reached; and a sixth trigger operation based on a completion control in the role display interface is detected.

In a second aspect, the present disclosure further provides a computer device. The computer device includes a processor and a memory storing computer programs. The processor, when executing the computer programs, implements steps of the game interaction method in the first aspect above.

In a third aspect, the present disclosure further provides a computer-readable storage medium, having computer programs stored therein. The computer programs, when executed by a processor, implements steps of the game interaction method in the first aspect above.

In a fourth aspect, the present disclosure further provides a computer program product. The computer program product includes computer programs. The computer programs, when executed by a processor, implements steps of the game interaction method in the first aspect above.

### BRIEF DESCRIPTION OF THE DRAWINGS

In order to describe the technical solutions of the embodiments of the present disclosure or the conventional art more clearly, the accompanying drawings required for describing the embodiments or for describing the conventional art will be briefly introduced as follows. Apparently, the accompanying drawings, in the following description, illustrate merely some embodiments of the present disclosure, for those of ordinary skill in the art, other drawings can also be obtained according to these accompanying drawings without making any creative efforts.

FIG. 1 is a schematic diagram illustrating an application environment of a game interaction method according to an embodiment.

FIG. 2 is a schematic flow chart illustrating a game interaction method according to an embodiment.

FIG. 3(a) is a schematic diagram illustrating a configuration of determining a target role in a role display interface according to an embodiment.

FIG. 3(b) is a schematic diagram illustrating a configuration of determining a target role in a role display interface according to another embodiment.

FIG. 4 is a schematic flow chart illustrating a game interaction method according to another embodiment.

FIG. 5 is a schematic diagram illustrating a configuration of role switching in a role display interface according to an embodiment.

FIG. 6(a) is a schematic diagram illustrating a configuration of role switching in a role display interface according to another embodiment.

FIG. 6(b) is a schematic diagram illustrating a configuration of role switching in a role display interface according to another embodiment.

FIG. 7(a) is a schematic diagram illustrating a configuration of displaying a plurality of role virtual objects in a role display interface according to an embodiment.

FIG. 7(b) is a schematic diagram illustrating a configuration of displaying role information in a role display interface according to an embodiment.

FIG. 7(c) is a schematic diagram illustrating a configuration of displaying role information in a role display interface according to another embodiment.

FIG. 8(a) is a schematic diagram illustrating a configuration of displaying prompt information in a role display interface according to an embodiment.

FIG. 8(b) is a schematic diagram illustrating a configuration of displaying prompt information in a role display interface according to another embodiment.

FIG. 8(c) is a schematic diagram illustrating a configuration of displaying prompt information in a role display interface according to another embodiment.

FIG. 9 is a schematic flow chart illustrating a game interaction method according to another embodiment.

FIG. 10(a) is a schematic diagram illustrating a configuration of displaying a role state list in a role display interface according to an embodiment.

FIG. 10(b) is a schematic diagram illustrating a configuration of displaying a role state list in a role display interface according to another embodiment.

FIG. 11 is a schematic diagram illustrating a configuration of displaying a browsing tag of a role virtual object in a role display interface according to an embodiment.

FIG. 12 is a schematic diagram illustrating a configuration of displaying a user state list in a role display interface according to an embodiment.

FIG. 13(a) is a schematic diagram illustrating a configuration of displaying a random selection control in a role display interface according to an embodiment.

FIG. 13(b) is a schematic diagram illustrating a configuration of displaying a cancel automatic assignment control in a role display interface according to an embodiment.

FIG. 14 is a schematic diagram illustrating a configuration of displaying a user state list in a role display interface according to another embodiment.

FIG. 15 is a structural block diagram illustrating a game interaction device according to an embodiment.

FIG. 16 is a structural block diagram illustrating a game interaction device according to another embodiment.

FIG. 17 is a structural block diagram illustrating a game interaction device according to another embodiment.

FIG. 18 is a diagram illustrating an internal structure of a computer device according to an embodiment.

### DETAILED DESCRIPTION OF THE EMBODIMENTS

In order to make the purpose, technical solutions and advantages of the present disclosure more clearly understood, the disclosure will be further described in detail with the accompanying drawings and embodiments. It should be understood that the specific embodiments described here are only used to explain the disclosure and not to limit the disclosure.

First of all, before specifically introducing the technical solutions of the embodiments of the present disclosure, the technical background or evolution of technology of the embodiments of the present disclosure is introduced. Generally, emerging strong social games such as a decryption game, an escape room game, and a plot reasoning game are mainly played offline. The role identities of users are determined by distributing paper role cards to the users. In addition, each user can also determine a role plot corresponding to the role identity through the role card, and the game can be started after the users' role identities and role plots are determined.

However, for the current form of the offline games, the users need to be at the same place at the same time and need to use game-related props, such as game cards, to play games. The game process also needs to be carried out in a specific scene, resulting in poor executability of such games.

For electronic games based on computer devices, the role selection methods are mainly for traditional electronic game projects such as a massive multiplayer online game (MMO), and a role-playing game (RPG). The operation of role assignment is relatively simple, and the human-computer interaction is not intelligent enough.

In view of the above-mentioned technical problems, embodiments of the present disclosure provide a game interaction method that enables online game operations through client devices, thereby improving the executability of the emerging strong social games, enhancing the intelligence and convenience of the human-computer interaction of the games, and improving the user experience.

The technical solutions involved in the embodiments of the present disclosure will be introduced below with reference to the application scenarios of the embodiments of the present disclosure.

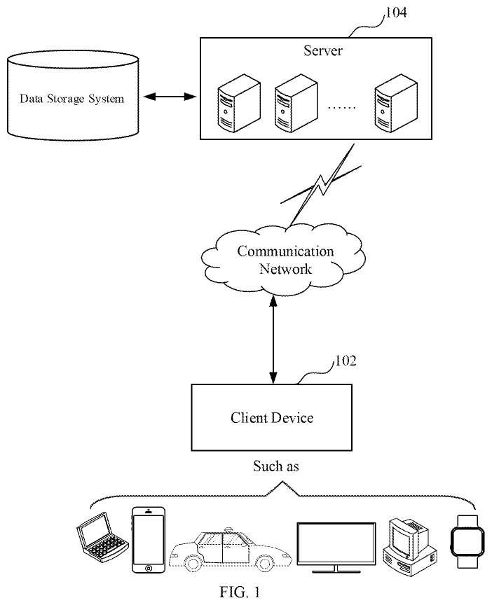

The game interaction method provided by the embodiments of the present disclosure can be applied to an application environment shown in FIG. 1. A client device 102 communicates with a server 104 through a communication network. A data storage system can store data that needs to be processed by the server 104. The data storage system can be integrated in the server 104, and can also be set on a cloud or other distributed servers. The client device 102 can be, but is not limited to, various personal computers, notebook computers, smart phones, tablet computers, smart TVs and portable wearable devices. The portable wearable devices can be smart watches, smart bracelets, head-mounted devices, and the like.

An application program supporting emerging strong social games is installed and running in the client device 102. The application program supports multiplayer online games. The user can select the corresponding role identity through the application program in the client device, and learn about the role plot corresponding to the role identity, so that the user can play role-playing games anytime and anywhere.

The server 104 may be implemented by an independent server, a server cluster composed of multiple servers, or a cloud server. The server 104 is configured to provide background services for application programs supporting role-playing games.

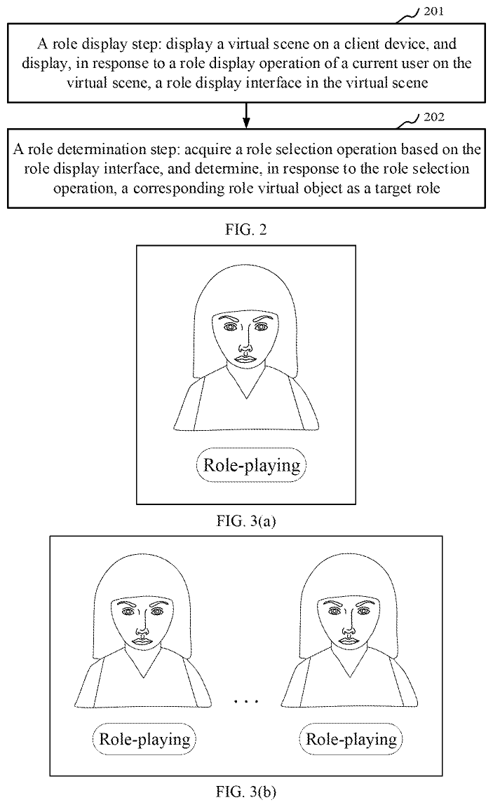

In an embodiment, as shown in FIG. 2, a game interaction method is provided. Taking the method applied to the client device in FIG. 1 as an example for illustration, the method includes the following steps.

In step 201, i.e., a role display step, a virtual scene is displayed on the client device, and a role display interface is displayed in the virtual scene in response to a role display operation performed by a current user on the virtual scene.

One or more role virtual objects are displayed in the role display interface. The role virtual objects are virtual objects set for the game roles in a target script in the game. There are differences between different role virtual objects to distinguish different game roles in the target script. During the development process, different configuration parameters can be set for different role virtual objects, including but not limited to object ID, object name, object description, object art image, object position, object action, etc. It should be noted that the application program with the emerging strong social games installed in the client device can support different scripts, and different scripts correspond to different game plots. The user can choose one of the scripts to play, and after the user determines the target script to play, the virtual scene corresponding to the target script is displayed on the client device.

Optionally, the virtual scene may be a first game scene at the start of the game, or a game scene corresponding to a specific stage in the game process, or a game scene corresponding to any stage in the game process, etc. In other words, the user can select the corresponding game role before the game starts, and can also select or change the corresponding game role during the game process. The virtual scene may be a two-dimensional (2D) or three-dimensional (3D) spatial scene modeled by computer programs, such as a whole scene of a hospital or a school, or a certain room scene. Generally, the number of the game roles in each game is equal to the number of the players or users, i.e., each user finally selects a role virtual object in one-to-one correspondence. Optionally, when the number of the game roles is greater than the number of the users, one user can also select multiple role virtual objects to play multiple game roles. Of course, the user can also select only one role virtual object to play one game role, and the game role corresponding to the unselected role virtual object in the target script can be played by a virtual user set and controlled by the computer programs.

Optionally, when the user selects the game role to play, a corresponding role display operation can be triggered based on the virtual scene displayed on the client device, so that the client device, in response to the role display operation, displays the role display interface in the virtual scene to display one or more role virtual objects corresponding to the target script. The role display operation may be a trigger operation on a role control displayed in the virtual scene, or a sliding operation on the virtual scene, for example, a side sliding operation on the virtual scene, or a specific gesture trigger operation on the virtual scene. The specific gesture trigger operation associates with the role display operation. The specific gesture can be a default gesture developed for the game or a user-defined gesture, including but not limited to three-finger swipe down, three-finger swipe up, drawing a circle, drawing a triangle, and other user-defined gesture patterns, etc. The embodiment of the present disclosure does not specifically limit the gesture type of the gesture trigger operation, and also does not specifically limit the form of the role display operation.

After detecting the role display operation of the user on the virtual scene, the client device displays the role display interface in the virtual scene. The role display interface can be displayed in a form of a pop-up window at a preset window position of the virtual scene, or can be displayed in suspension in the virtual scene. Users can also perform operations such as zooming out, zooming in, and closing on the role display interface. It should be noted that when the size of the role display interface is different, the displayed content is also different, for example, the number of displayed role virtual objects is different.

Further, the one or more role virtual objects are displayed in the role display interface. Optionally, the number of the role virtual objects displayed in the role display interface can be set by the user, of course, it can also be a default. If there are a plurality of role virtual objects displayed in the role display interface, the plurality of virtual role objects can be displayed in the form of one row and multiple columns, or can be displayed in the form of multiple rows and multiple columns, or can be displayed in the form of multiple rows and one column, etc. The plurality of virtual role objects can also be displayed in a tree structure. The display form of the virtual role objects is not limited in the embodiments of the present disclosure.

Furthermore, role information corresponding to each of the role virtual objects can also be displayed in the role display interface, and the role information can include at least one of a role name, a role gender, a role age, a role introduction, or role plot.

In step 202, i.e., a role determination step, a role selection operation is acquired based on the role display interface, and a corresponding role virtual object is determined as a target role in response to the role selection operation.

Optionally, the role display interface can include a role selection control, and the user performs the role selection operation by triggering the role selection control. After detecting the trigger operation of the user based on the role selection control in the role display interface, the client device acquires the role selection operation and determines, in response to the role selection operation, the corresponding role virtual object as the target role played by the user.

Exemplarily, as shown in FIG. 3(a), in a case that the role display interface includes one role virtual object, the role display interface may include one role selection control. The “Role-playing” control in FIG. 3(a) is the role selection control. After the role-playing control is triggered, the client device takes the role virtual object currently displayed in the role display interface as the target role played by the user. As shown in FIG. 3(b), in a case that the role display interface includes a plurality of role virtual objects, the role display interface may include a plurality of role-playing controls corresponding to the role virtual objects. After the client device detects that one of the role-playing controls is triggered, the role virtual object corresponding to the triggered role selection control is taken as the target role played by the user.

Optionally, the role selection operation may also include triggering operations on the role virtual object, such as clicking, double-clicking, sliding, etc. Exemplarily, the user can double-click the role virtual object to select the role virtual object as the target role played by the user. Of course, the role selection operation may also be in other forms, the form of the role selection operation is not limited in the embodiments of the present disclosure.

In the above game interaction method, the virtual scene is displayed on the client device, and in response to the role display operation of the current user on the virtual scene, the role display interface is displayed in the virtual scene. Then the role selection operation is acquired based on the role display interface, and in response to the role selection operation, the corresponding role virtual object is determined as the target role. The one or more role virtual objects are displayed in the role display interface. In other words, the embodiments of the present disclosure provide an online game method. By installing an application program for supporting emerging strong social games on the client device, the application program can display the virtual scene of the game for the user, and provide the user with an interactive game role selection operation. In addition, the client device can also display the plurality of role virtual objects in the game for the user through the application program, so that the user can select a role more intuitively and flexibly. Compared to using paper game cards to determine the role identity played by the user, the user can participate in the game without gathering offline, and can start the game anytime and anywhere, which improves the executability of the game. Compared to traditional electronic games that determine the role identity played by the user through the role selection operation, the intelligence and operation diversity of the human-computer interaction can be improved, and the convenience and flexibility of the game can also be improved.

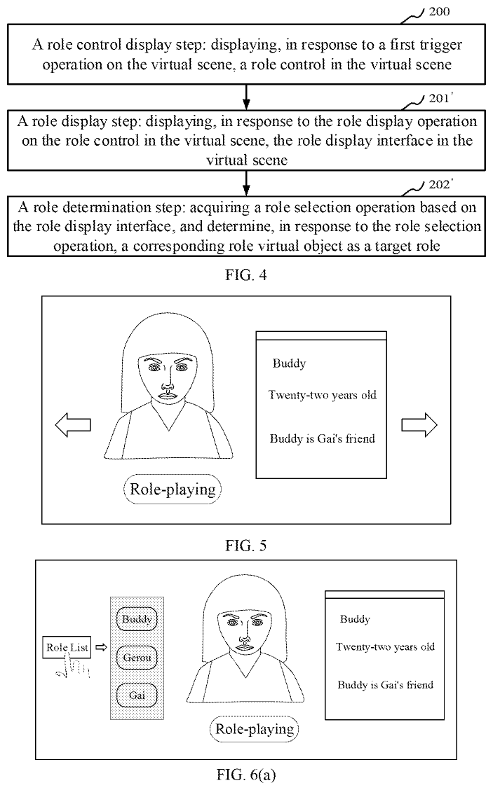

FIG. 4 is a schematic flow chart illustrating a game interaction method according to another embodiment. This embodiment relates to another optional implementation process for the client device to display the role display interface. On the basis of the above embodiment, as shown in FIG. 4, before the step 201 shown in FIG. 2, the method includes following steps.

In step 200, i.e., a role control display step, at least one role control is displayed in the virtual scene in response to a first trigger operation on the virtual scene.

The at least one role control can be a text control including the role name, or can be a role character control including a role image. The number of the at least one role control can be one or more, for example, the at least one role control can include role controls corresponding to all role virtual objects of the target script. In the embodiment of the present disclosure, there is no specific limitation on the form of the role control and the number of the role control displayed in the virtual scene.

Optionally, the first trigger operation can be a sliding operation on the virtual scene, including a side sliding operation on the virtual scene. Exemplarily, the at least one role control can be displayed in the virtual scene by sliding from a left side to a right side on the virtual scene, and the role control can be suspended and displayed in the left area of the virtual scene. In a case that there is a role control displayed in the virtual scene, the role control can be eliminated or hidden by sliding from the right side to the left side on the virtual scene.

Optionally, after the first trigger operation is performed on the virtual scene, the at least one role control displayed in the virtual scene can also be displayed in the virtual scene in the form of the pop-up window. A plurality of the role controls in the pop-up window can be displayed in a list form. In a case that the pop-up window cannot display all the role controls, different role controls can also be switched and displayed by sliding up and down. Optionally, the at least one role control can also be displayed in the central area of the virtual scene and can include role controls corresponding to each of the role virtual objects, or can only include the role control corresponding to the role virtual object played by the user.

Optionally, the role control is fixed at a certain position in the virtual scene, and the user can also flexibly adjust the position of the role control. For example, the role control can be a movable floating ball in the virtual scene. By dragging the floating ball, the role control can be moved to any position in the virtual scene.

It should be noted that the type of the first trigger operation, the display form of the role control, the display number of the role control, etc. involved in the above embodiments can be flexibly combined and are not limited to the implementation form in the above single embodiments. Exemplarily, the implementation of the step 200 can also include displaying the role control corresponding to each of the role virtual objects in a horizontal row by sliding down from the top of the virtual scene.

In step 201′ corresponding to the above step 201, i.e., the role display step, the role display interface is displayed in the virtual scene in response to a role display operation on the at least one role control in the virtual scene.

Optionally, when the role control is displayed in the virtual scene, the user can enter the role display interface through the role control. The role display operation can be a trigger operation on the role control, i.e., the user can trigger the role control to make the client device acquire the role display operation for the role control, then the client device responds to the role display operation to display the role display interface in the virtual scene. Optionally, one or more role virtual objects can be displayed in the role display interface. Exemplarily, when a role control corresponding to a certain role virtual object is triggered by the user, the role display interface can only display the role virtual object corresponding to the role control. Alternatively, the role display interface can also display a plurality of role virtual objects including the role virtual object corresponding to the role control, and the role virtual object corresponding to the role control can be highlighted or displayed in the center. For example, if the role control is the movable floating ball in the virtual scene described above, the user can enter the role display interface by triggering the floating ball.

In step 202′, i.e., the role determination step, a role selection operation is acquired based on the role display interface, and a corresponding role virtual object is determined as a target role in response to the role selection operation.

The specific implementation can be referred to the related description in the step 202 of the embodiment corresponding to FIG. 2, and details are not repeated here.

In this embodiment, the client device displays the role control in the virtual scene in response to the first trigger operation on the virtual scene, and then displays the role display interface in the virtual scene in response to the role display operation on the role control in the virtual scene, so that the client device displays the corresponding role virtual object in the role display interface according to a user selection, thereby improving the user experience.

In an optional embodiment of the present disclosure, in a case that one role virtual object and role information of the role virtual object are displayed in the role display interface, the client device can also display another virtual role object and role information of the another virtual role object in the role display interface in response to a second trigger operation on the role display interface. Optionally, the second trigger operation may include operations such as clicking, double-clicking, or sliding on the role display interface, and may also include operations such as sliding or dragging the virtual role object displayed in the role display interface, and may further include operations such as clicking and double-clicking on a role switching control in the role display interface.

Exemplarily, the user can click the right side of the currently displayed role virtual object to switch and display the next role virtual object adjacent to the currently displayed role virtual object and the role information of the next role virtual object.

Exemplarily, the user can also perform a left sliding operation on the role display interface to switch and display the next role virtual object adjacent to the currently displayed role virtual object and the role information of the next role virtual object.

Exemplarily, the user can also drag the currently displayed role virtual object to the left to switch and display the next role virtual object adjacent to the currently displayed role virtual object and the role information of the next role virtual object.

Exemplarily, the user can also click a first role switching control to switch and display the next role virtual object adjacent to the currently displayed role virtual object and the role information of the next role virtual object. Optionally, the first role switching control may be a control with an arrow pointing to the right, as shown in FIG. 5. Accordingly, the role display interface may also include a second role switching control, and the second role switching control can be a control with an arrow pointing to the left. By triggering the second role switching control, the previous role virtual object adjacent to the currently displayed role virtual object and the role information of the previous role virtual object can be switched and displayed. Optionally, the first role switching control and the second role switching control may be set above or below the currently displayed role virtual object, or respectively set on the left and right sides of the role virtual object. Of course, the first role switching control and the second role switching control may also be set on other positions of the role display interface, the embodiments of the present disclosure do not limit the specific positions of the first role switching control and the second role switching control.

In this embodiment, in the case that one role virtual object and the role information of the role virtual object are displayed in the role display interface, the client device can display another role virtual object and the role information of the another role virtual object besides the role virtual object in response to the second trigger operation on the role display interface, so as to realize the switching operation of the role virtual objects and improve the intelligence of the human-computer interaction.

In an optional embodiment of the present disclosure, based on the above-mentioned embodiments, the role display interface may also include a role control list. Based on this, the client device can also display the role virtual object corresponding to the role control and the role information of the role virtual object corresponding to the role control in the role display interface in response to a third trigger operation on the role control in the role control list.

Optionally, the role control list may be provided on the left side of the role display interface. The role control list may include role controls corresponding to all of the role virtual objects of the target script, and each role control can be a text control including the role name. Optionally, in a case that the number of the role controls is too large to display all role controls in the role control list, the role control list can also support sliding operations to display all role controls in a scrolling manner. In addition, the length of the role control list can also be set by the user, so that the user can flexibly adjust the number of the role controls displayed in the role control list.

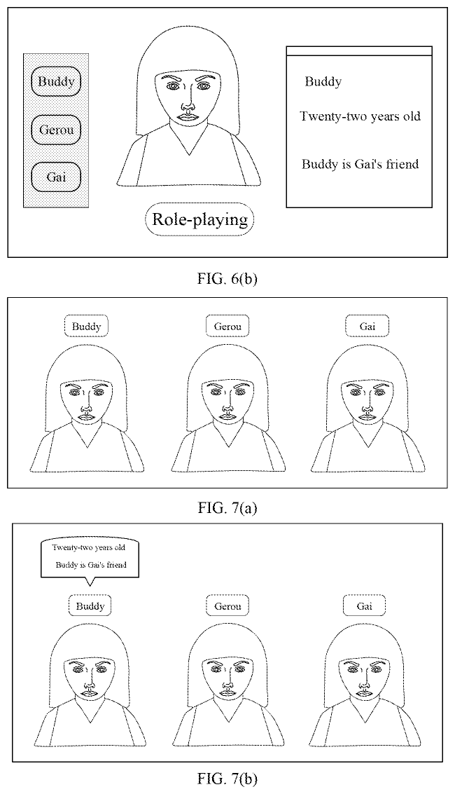

Optionally, the role control list can be fixedly set in the role display interface. Alternatively, the role control list is hidden in the role display interface, and the client device display the role control list in response to the trigger operation on the role display interface. Exemplarily, as shown in FIG. 6(a), the role display interface includes a role list control, i.e., the text button control marked with “Role List”. When the user clicks on or pulls down the role list control, the client device can display the role control list in the role display interface in response to the user's trigger operation on the role list control.

Based on the role control list, the user can directly select a target role control corresponding to the role virtual object that the user wants to view, so that the client device can directly switch the role virtual object currently displayed in the role display interface to the role virtual object corresponding to the target role control selected by the user, and display the role information of the role virtual object corresponding to the target role control, so as to improve the efficiency of the role switching, thereby improving the user experience.

Exemplarily, as shown in FIG. 6(b), in the case that one role virtual object and the role information of the role virtual object are displayed in the role display interface, the role control list can also be displayed in the left area of the role display interface, and the user can directly view a certain role virtual object and role information corresponding to the certain role virtual object through the role control list. For example, referring to FIG. 6(b), when the role virtual object “Buddy” is displayed in the role display interface, the user can select the role control “Gai” through the role control list, then the client device displays the role virtual object “Gai” and the role information corresponding to “Gai” in the role display interface in response to the user's trigger operation on the role control “Gai”, i.e., the client device directly switches the role virtual object “Buddy” to the role virtual object “Gai”. Optionally, based on the embodiments shown in FIG. 6(a) and FIG. 6(b), the client device can also switch the role virtual objects and the corresponding role information displayed in the role display interface in response to the user's left or right sliding operation on the role display interface.

In an optional embodiment of the present disclosure, in a case that a plurality of role virtual objects are displayed in the role display interface, the client device can display the role information of the role virtual objects in the role display interface in response to a fourth trigger operation on the role virtual objects.

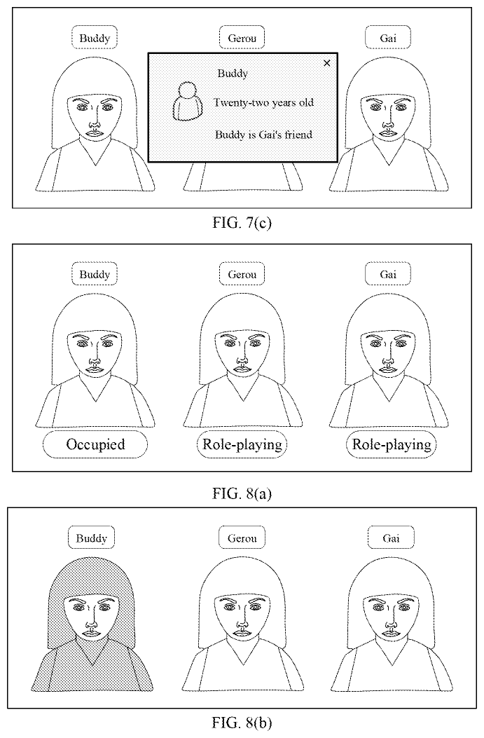

Optionally, in the case that the plurality of role virtual objects are displayed in the role display interface, considering the size and aesthetics of the role display interface, only the role names of each of the role virtual objects are displayed. Other role information of the role virtual objects can be displayed based on the user's trigger operation on the corresponding role virtual objects, as shown in FIG. 7(a). In other words, the user can select and trigger any role virtual object, so that the client device displays the role information of the role virtual object in the role display interface. Specifically, the fourth trigger operation can be performed in an area where the character modeling of the role virtual object is located. Alternatively, the fourth trigger operation can be performed in an area where the name box at the top of the role virtual object is located. Exemplarily, as shown in FIG. 7(b), the role information of the role virtual object can be displayed in the form of the pop-up window around the role virtual object. Similarly, the user can perform the fourth trigger operation by triggering the area where the character modeling of the role virtual object is located or by triggering the area where the name box at the top of the role virtual object is located, so that the client device displays the role information of the role virtual object in the role display interface. In addition, the size of the pop-up window can be determined based on the amount of the role information of the role virtual object, and the background and transparency of the pop-up window can be set by default or user-defined.

Optionally, the fourth trigger operation performed by the user on the role virtual object may include operations such as clicking, double-clicking, dragging, etc. The embodiments of the present disclosure do not specifically limit the specific form of the fourth trigger operation, as long as the fourth trigger operation can instruct the client device to display the role information of the role virtual object in the role display interface.

Optionally, as shown in FIG. 7(c), the client device displays the role information of the role virtual object by superimposing an information display sub-interface in the role display interface, and the information display sub-interface includes the role information of the role virtual object. Exemplarily, after the user triggers a certain role virtual object, the client device superimposes and displays the information display sub-interface in the central area of the role display interface.

Further, based on the embodiment shown in FIG. 7(c), the information display sub-interface further includes a closing component, such as the X in the upper right corner of the information display sub-interface shown in FIG. 7(c). The information display sub-interface can be closed and returned to the role display interface through the closing component. Optionally, the information display sub-interface can also include a role-playing control (not shown in the figure). The user selects the role virtual object as the target role to play by triggering the role-playing control, i.e., performing the role selection operation on the role-playing control. Optionally, the information display sub-interface can also support role switching operations, and various implementations of switching the role virtual objects in the role display interface in the above-mentioned embodiments can be referred to. The role switching operations include operations such as clicking, double-clicking, sliding on the information display sub-interface, and can also include the role switching performed by the first role switching control and the second role switching control as shown in FIG. 5 above.

In this embodiment, in the case that the plurality of role virtual objects are displayed in the role display interface, the client device can display the role information of the role virtual object in the role display interface in response to the fourth trigger operation on the role virtual object. This embodiment provides another display method of the game roles and the role information, which enriches the ways of the game interaction and improves the intelligence of the human-computer interaction.

In an optional embodiment of the present disclosure, for a multiplayer online game, each participating user will select a role virtual object as his game role in the game, and one role virtual object can only correspond to one user. In other words, once a role virtual object is selected by the user, it cannot be selected by other users except this user. Based on this, in this embodiment, the client device can also display a prompt information in the role display interface when the role virtual object has been selected by another user, and the prompt information is configured to indicate that the role virtual object has been selected. When the role virtual object is selected by the current user, a deselection control is displayed in the role display interface, so that the current user can deselect the role virtual object through the deselection control.

On the one hand, the case that the role virtual object is selected by another user will be described below.

Optionally, in the case that the role virtual object is determined as the target role by adopting the above-mentioned selection method of triggering the role-playing control, if the role virtual object is selected by another user, there are two cases as follows. In one case that only one role virtual object is displayed in the role display interface, the role-playing control can be replaced with an occupied marker, and the occupied marker is configured to indicate that the role virtual object has been selected by another user. In another case that a plurality of role virtual objects are included in the role display interface and each of the role virtual objects corresponds to one role-playing control, the role-playing control corresponding to the role virtual object selected by another user can be replaced with the occupied marker. As shown in FIG. 8(a), when the role “Buddy” is selected by another user, i.e., when another user selects “Buddy” by triggering the role-playing control (refer to FIG. 3(b)) under the role virtual object “Buddy”, the marker “occupied” can be displayed under the role “Buddy” in the current user's role display interface.

Optionally, in the case that the role virtual object is determined as the target role by triggering the area where the character modeling of the role virtual object is located, if the role virtual object is selected by another user, the role virtual object can be adjusted from a triggerable state to a non-triggerable state in the role display interface. The triggerable state indicates that the role virtual object can be selected as the target role through the trigger operation (i.e., the role selection operation described in the preceding embodiment), and the non-triggerable state indicates that it is forbidden to select the role virtual object as the target role through the trigger operation. Optionally, as shown in FIG. 8(b), when the role “Buddy” is selected by another user, i.e., when another user selects “Buddy” by triggering the character modeling of the role “Buddy”, the role virtual object “Buddy” in the current user's role display interface is in the non-triggerable state. The role virtual object in the non-triggerable state may be displayed as a grayscale object.

On the other hand, the case that the role virtual object is selected by the current user will be described below.

Optionally, in the case that the role virtual object is determined as the target role by triggering the role-playing control, if the role virtual object is selected by the current user, there are two cases as follows. In one case that only one role virtual object is displayed in the role display interface, the role-playing control can be replaced with the deselection control, and the deselection control is configured to deselect the role virtual object. In another case that a plurality of role virtual objects are included in the role display interface and each of the role virtual objects corresponds to one role-playing control, the role-playing control corresponding to the role virtual object selected by the current user can be replaced with a deselection control. As shown in FIG. 8(c), when the current user selects “Buddy” by triggering the role-playing control under the role “Buddy”, the role-playing control below “Buddy” is modified and replaced with a deselection control.

Optionally, in the case that the role virtual object is determined as the target role by triggering the role virtual object, if the role virtual object is selected by the current user, the role virtual object can remain in the triggerable state in the role display interface. In this case, if the role virtual object is triggered again, the role virtual object can be switched from a selected state to an unselected state, i.e., the current user deselects the role virtual object.

Of course, in the case of adopting the selection method of triggering the role virtual object, if the role virtual object is selected by the current user, the role virtual object can remain in the triggerable state, or can be adjusted to be in the non-triggerable state in the role display interface. In addition, in the role display interface, for the role virtual object selected by the current user, a deselection control can be additionally displayed, and this deselection control is convenient for the user to deselect the role virtual object.

It should be noted that, different selection methods correspond to different ways of prompt information and different deselection methods, and the ways of prompt information and deselection methods can be adaptively set according to the selection method.

In this embodiment, when the role virtual object has been selected by another user, the prompt information is displayed in the role display interface to prompt the current user that the role virtual object has been selected. When the role virtual object is selected by the current user, the deselection control is displayed in the role display interface, so that the current user can deselect the role virtual object through the deselection control. The intelligence of the human-computer interaction can be further improved.

In an optional embodiment of the present disclosure, the role display interface may further include a role state list. The role state list includes current states of all of the role virtual objects of the currently selected target script.

Optionally, the current state of the role virtual object may include the selected state and the unselected state of the role virtual object. The selected state and the unselected state can be marked and distinguished by different colors, icons, text marks, etc., so that the user can quickly learn the current selection state of each of the role virtual objects according to the role state list.

Optionally, the current state of the role virtual object may also include a user state after the role virtual object is selected. The user state may be user information, such as a user name. For the unselected role virtual objects, the user state corresponding thereto may be an empty state or a user-pending state. In other words, by means of the role state list in this embodiment, the user can quickly learn about the users who have selected the game roles and the game roles corresponding to these users, and can also quickly lock the game roles that have not been selected.

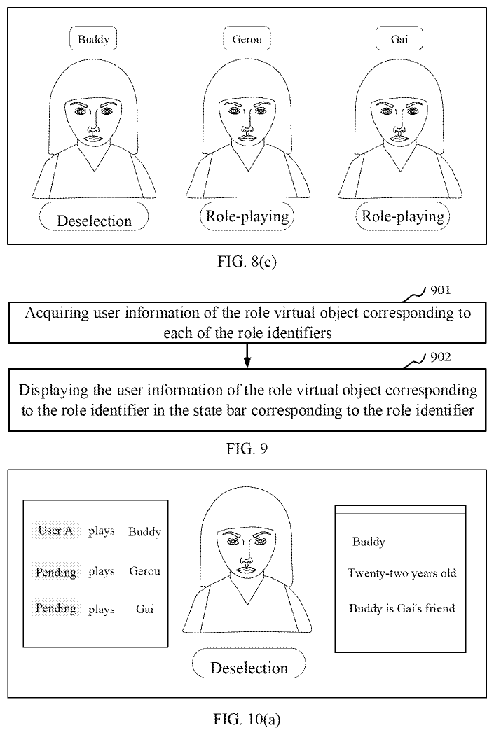

In an optional embodiment, the role state list may include a role identifier corresponding to each of the role virtual objects and a state bar corresponding to each of role identifiers. Optionally, the state bar can be configured to indicate the selection state of the role virtual object, and can also be configured to indicate the user state corresponding to the role virtual object. In the case that the state bar indicates the user state corresponding to the role virtual object, on the basis of the above-mentioned embodiments, as shown in FIG. 9, the game interaction method may further include the following steps.

In step 901, user information of the role virtual object corresponding to each of the role identifiers is acquired.

Optionally, the client device can send a state acquisition request to the server at a preset frequency, and the state acquisition request carries all of the role identifiers in the role state list. In response to the state acquisition request, the server acquires role selection information corresponding to this client device from a database, and role selection information of other client devices associated with this client device in the same game. Then the user information of the role virtual object corresponding to each of the role identifiers is determined based on the role selection information of this client device and other client devices associated with this client device.

Optionally, the server may further include an association table for the multiplayer online game, and the association table includes an association relationship between each of the role virtual objects and the user information of the multiple users. Exemplarily, the multiplayer online game may correspond to a unique game room number, the association table corresponding to the multiplayer online game can be found through the game room number, and the user information of the role virtual object corresponding to each of the role identifiers can be acquired through the association table. The server can update the association table of the multiplayer online game corresponding to the game room number in real time according to the role selection state of each of the users in the game room number, so that the client device can accurately display the role state list in real time.

Optionally, the server can also return the changed user information of the role virtual object corresponding to the role identifier to the client device when it is determined that the user information of the role virtual object changes. Changes in the user information of the role virtual object include the user selecting the role virtual object and the user deselecting the role virtual object.

In step 902, the user information of the role virtual object corresponding to the role identifier is displayed in the state bar corresponding to the role identifier.

Optionally, in the case that the user information of the role virtual object corresponding to the role identifier is acquired, the client device displays the user information of the role virtual object corresponding to the role identifier in the state bar corresponding to the role identifier. In the case that the user information of the role virtual object corresponding to the role identifier is not acquired, default information is displayed in the state bar corresponding to the role identifier. This default information may be a default field, such as “user is pending” or “player is pending”.

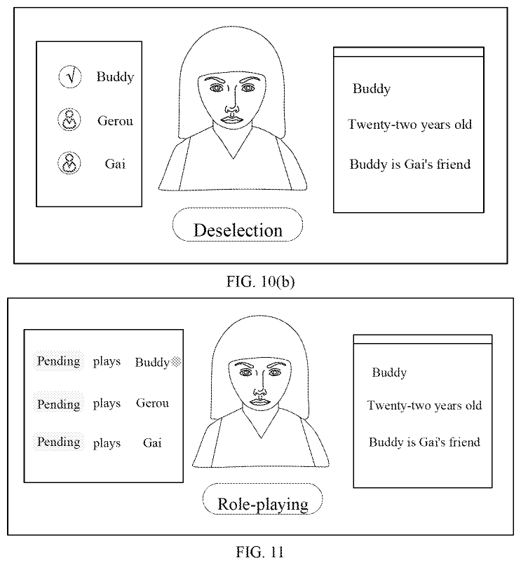

Exemplarily, as shown in FIG. 10(a), the role state list includes the role identifier corresponding to each of the role virtual objects, the state bar corresponding to each of the role identifier, and a constant field corresponding to each of the role identifier. As shown in FIG. 10(a), the role identifier is the role name in the role state list, such as Buddy, Gerou, and Gai. The user information can be displayed in the state bar corresponding to the role identifier, such as “User A” who plays Buddy. When the role has not been selected by the user, the default field, such as “Pending”, “Player is Pending”, etc., can be displayed in the state bar corresponding to the role identifier. The constant field may be “Role-playing”. The constant field may also be other fields, such as “Acting”. The embodiments of this disclosure do not limit the specific content of the constant field.

Based on the above method, in the case that the selection state of the role virtual object is marked in the state bar, similarly, the client device can acquire the selection state of the role virtual object corresponding to each of the role identifiers from the server, and determine the corresponding state mark according to the selection state. Exemplarily, as shown in FIG. 10 (b), in the case that the role virtual object corresponding to the role identifier is in the selected state, a first state mark ( [symbol] as shown in FIG. 10(b)) in the selected state is displayed in the state bar corresponding to the role identifier. In the case that the role virtual object corresponding to the role identifier is in the unselected state, a second state mark ( [symbol] as shown in FIG. 10(b)) in the unselected state is displayed in the state bar corresponding to the role identifier.

In this embodiment, the role display interface further includes the role state list for displaying the current states of all of the role virtual objects, and the user information of the role virtual objects corresponding to the role identifiers can be displayed in the role state list, so that the user can quickly learn the specific role played by each player-user, and quickly lock the unselected game roles, which can improve the intelligence of the human-computer interaction and improve the user experience.

In an optional embodiment of the present disclosure, mark information corresponding to the role virtual object can also be displayed in the role state list, and the mark information is configured to indicate the role virtual object currently browsed by the user. Optionally, in the case that only one role virtual object is displayed in the role display interface, or, in the case that a plurality of role virtual objects are displayed in the role display interface and the user is currently viewing the role information of one of the role virtual objects, the mark information corresponding to the role virtual object can be displayed in the role state list. Optionally, the mark information may be a mark symbol. For example, an additional mark symbol is added to the role virtual object in the role state list. Alternatively, the mark information may also be a highlighting of the role virtual object. For example, the role virtual object in the role state list is highlighted, etc. Exemplarily, as shown in FIG. 11, the mark information may be an additional circular mark symbol after the name of the role virtual object currently browsed by the user.

In this embodiment, the mark information corresponding to the role virtual object is displayed in the role state list, so that the user can clarify the role virtual object currently browsed through the mark information, thereby improving the user experience.

In an optional embodiment of the present disclosure, the role display interface may also include a user state list. The user state list may include at least one of the total number of users, the number of users who have selected the role virtual objects, or the role selection state of each of the users. The role selection state of the user may include the selected state and the unselected state.

Optionally, the client device can acquire information such as the number of users participating in the game, the number of users who have selected the role virtual objects, and the role selection state of each of the users from the server. The client device can update the user state list in real time according to the information such as the number of users participating in the game, the number of users who have selected role virtual objects, and the role selection state of each of the users.

Optionally, the user state list may include a first part and a second part. The first part can be configured to display the total number of users and the number of users who have selected role virtual objects. The second part can be configured to display the role selection state of each of the users. Optionally, the first part may be displayed in the form of the total number of users—the number of users who have selected role virtual objects, or the number of users who have selected role virtual objects/the total number of users, or the total number of users (the number of users who have selected role virtual objects), etc. Of course, there may also be other display forms. The embodiments of the present disclosure do not specifically limit the display form of the first part, as long as the first part displays the total number of users and the number of users who have selected role virtual objects.

Optionally, the second part may be displayed in the form of a list. The list includes each of the users and a role selection state bar corresponding to each of the users. Alternatively, the list may only include the role selection state bar corresponding to each of the users arranged in a preset order. The preset order can be in the order of the first letters of the user names, or in the order in which the user entered the game, and the like.

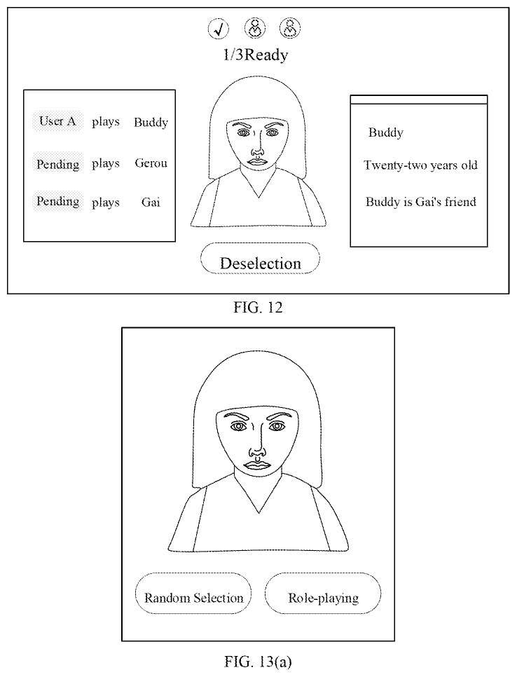

Optionally, the first part and the second part in the user state list can be distributed in a vertical manner or horizontal manner, which is not limited thereto. In addition, this embodiment of the present disclosure does not specifically limit the position of the user state list in the role display interface. Exemplarily, as shown in FIG. 12, the user state list is set in the top center area of the role display interface, the first part is located below the second part in the user state list, the first part is displayed in the form of the number of users who have selected role virtual objects/the total number of users, and the second part is displayed in a horizontal arrangement.

In this embodiment, by displaying the user state list in the role display interface, the user can visually view the number of users participating in the game, the number of users who have selected the role virtual objects, and the role selection state of each of the users, which further improves the intelligence of the human-computer interaction.

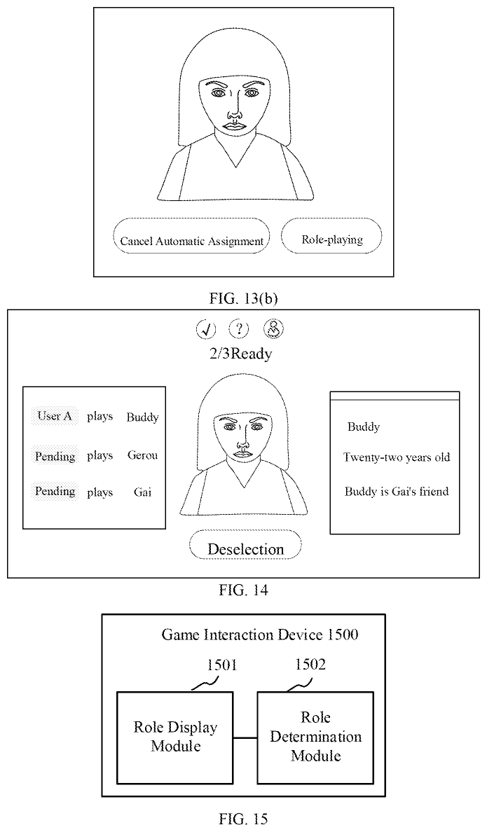

In an optional embodiment of the present disclosure, as shown in FIG. 13(a), the role display interface may also include a random selection control, i.e., the control marked with the word “Random Selection” at the bottom of the role virtual object in the figure. Correspondingly, in the above-mentioned step 201, the role determination step can also include: randomly determining, in response to a fifth trigger operation on the random selection control in the role display interface, a role virtual object as the target role from all of the unselected role virtual objects.

That is to say, in this embodiment, the user does not need to choose the played game role, instead, the client device automatically assigns a game role to the user. When the user triggers the random selection control, the client device randomly determines the role virtual object for the user as the target role to be played by the user from all of the unselected role virtual objects.

Optionally, the fifth trigger operation may include operations such as clicking, double-clicking, sliding, dragging, etc. Exemplarily, the user can click the random selection control so that the client device randomly assigns the target role to the user. Optionally, after detecting the user's fifth trigger operation on the random selection control, the client device can randomly determine the role virtual object as the user's target role from all of the unselected role virtual objects at a current moment.

Optionally, the client device can also randomly determine the role virtual object as the target role from all of the unselected role virtual objects after detecting the user's fifth trigger operation on the random selection control and after a preset time period is reached. The preset time period may be a difference time period between a preset role selection time period and an elapsed time period. The preset role selection time period is the time period from the start of selecting the role to the end of selecting the role, and the elapsed time period is the time period between the moment when the role selection is started and the current moment. In other words, the client device can randomly determine the role virtual object as the user's target role from all of the unselected role virtual objects at the end of the preset time period, i.e., at the end of selecting the role. For example, the preset role selection time period is 1 minute, and the user triggers the random selection control at the 10^{th} seconds after starting the selection of the role, so the elapsed time period is 10 seconds, and it can be determined that the preset time period is 50 seconds, which is obtained by subtracting the elapsed time period of 10 seconds from the role selection time period of 1 minute. At the 50th second after the user triggers the random selection control, the role selection time period ends synchronously, that is to say, the client device randomly determines the role virtual object as the user's target role from all of the unselected role virtual objects at the end of the role selection.

Optionally, the preset time period may also be any time period shorter than the preset role selection time period. In this case, if the preset time period is smaller than the difference time period defined above, i.e., if the role selection has not ended after the preset time period from the current moment in which the user triggers the random selection control, the client device can randomly determine the role virtual object as the user's target role from all of the unselected role virtual objects at the end of the preset time period. If the preset time period is greater than or equal to the difference time period defined above, i.e., if the role selection has ended after the preset time period from the current moment in which the user triggers the random selection control, the client device can randomly determine the role virtual object as the user's target role from all of the unselected role virtual objects at the end of the difference time period, i.e., at the end of selecting the role. For example, the preset time period is a constant time period of 20 seconds, and the preset role selection time period is 1 minute. If the user triggers the random selection control at the 10^{th} second after starting the selection of the role, the role selection has not ended 20 seconds later. Then the client device randomly determines the role virtual object as the user's target role from all of the unselected role virtual objects at the 30th second after starting the selection of the role. If the user triggers the random selection control at the 45th second after starting the selection of the role, the role selection has ended 20 seconds later. Then the client device can randomly determine the role virtual object as the user's target role from all of the unselected role virtual objects at the end of selecting the role, i.e., at the 60th second after starting selecting the role.

Further, after the random selection control is triggered, the random selection control can also be replaced with a cancel automatic assignment control, as shown in FIG. 13(b). The cancel automatic assignment control is configured to deselect the target role. That is to say, if the user is dissatisfied with the target role randomly assigned by the client device, the user can also cancel the automatic assignment, i.e., cancel the target role assigned by the client device. The user can deselect the target role by triggering the cancel automatic assignment control before the end of the role selection. If the user does not trigger the cancel automatic assignment control after the end of the role selection, it is determined that the user has selected the target role. Optionally, the user can also exit the role selection before the end of the role selection, i.e., exit from the role display interface to the virtual scene. The client device determines that the user has selected the target role when the user exits. Optionally, after the user exits, if the role selection has not ended, the user can re-enter the role display interface and reselect the game role that he wants to play from all of the unselected role virtual objects. The fact that the role selection has not ended indicates that there are other users who have not completed the role selection.

In addition, during the role selection stage, if the user neither selects the corresponding target role nor triggers the random selection control, the client device can randomly determine a role virtual object as the target role played by the user from all of the unselected role virtual objects at the end of the role selection.

Furthermore, after the random selection control is selected by the user, for the user state list involved in the above-mentioned embodiments, the role selection state of the user may also include a to-be-selected state. Correspondingly, in the second part of the user state list in the role display interface, the role selection state bar of the user displays a display icon corresponding to the to-be-selected state, such as the display icon [symbol] corresponding to the to-be-selected state shown in FIG. 14. The display icon corresponding to the to-be-selected state is configured to indicate that the role of the user is randomly assigned.

In this embodiment, the random selection control is also provided for the user in the role display interface, so as to randomly assign the game role to the user without the need for the user to select the role. A variety of role selection methods are provided for the user, providing convenience for the user, enriching the functionality of the human-computer interaction, and further improving the intelligence of the human-computer interaction.

In an optional embodiment of the present disclosure, the above game interaction method further includes: the client device exiting to the virtual scene when determining that a preset exit condition is satisfied. Optionally, the preset exit condition includes any one of the following: all of the users corresponding to the virtual scene have completed the role selection, the preset role selection time period has been reached, or a sixth trigger operation based on a completion control in the role display interface has been detected.

In this embodiment, two methods of exiting the role selection stage are provided, including synchronous exit and asynchronous exit. The synchronous exit refers to the exit when all of the users have completed the role selection and the preset role selection time period is reached, in other words, the synchronous exit means that all of the users exit the role selection stage at the same time. The asynchronous exit means that the user triggers the completion control before the end of the role selection, i.e., the user exits the role selection stage first. In the asynchronous exit scenario, when the user exits the role selection stage, it will not affect the role selection of other users.

Optionally, for the method of exiting the role selection stage, users can adaptively adjust the method of exiting the role selection stage through related configurations. Different exiting methods can be configured for multiple users in the same game, and the server controls the role selection stage of each of the users based on the exiting method set by each of the users. Exemplarily, it is assumed that the game includes three users, which are user A, user B, and user C. The exiting method of the user A is the asynchronous exit, and the exiting methods of the user B and the user C are the synchronous exit. In a first case, the user A exits asynchronously when completing the role selection, and after the user B completes the role selection, the user B and the user C exit at the same time when the user C completes the role selection. In a second case, the user A exits asynchronously when completing the role selection, and if the user B completes the role selection and the user C does not perform the role selection, the user B and the user C exit at the same time when the role selection stage is completed, and the client device randomly assigns a target role to the user C. In a third case, if the user A completes the role selection but does not exit, the user A, the user B and the user C exit at the same time after the user B and the user C complete the role selection. In a fourth case, the user A does not perform the role selection, and the user B and the user C complete the role selection, then the user A, the user B and the user C exit at the same time when the role selection is completed, and the client device randomly assigns a target role to the user A, and so on.

It should be noted that the examples provided above are only used to illustrate the exiting method and are not used to specifically limit the implementation of the exiting method. In practical applications, there are other reasonable implementation methods, which are not listed here.

In this embodiment, a variety of methods of exiting the role selection stage are provided. The exiting methods are diverse and the settings are flexible, which can meet the different needs of the users and improve the flexibility and the intelligence of the human-computer interaction.

It should be understood that although the individual steps in the flowcharts involved of the embodiments as described above are shown sequentially as indicated by the arrows, the steps are not necessarily performed sequentially in the order indicated by the arrows. Unless explicitly stated herein, these steps are performed in no strict order and they can be performed in any other order. Moreover, at least some of the steps in the flowcharts involved of the embodiments as described above may include multiple steps or multiple stages that are not necessarily performed at the same moment of completion, but may be performed at different moments, and the order in which these steps or stages are performed is not necessarily sequential, but may be performed alternately or alternately with other steps or at least some of the steps or stages in other steps.

Based on the same inventive concept, embodiments of the present disclosure also provide a game interaction device for implementing the game interaction method as described above. The solution to the problem provided by the device is similar to the implementation of the method documented above, so the specific limitations in the one or more embodiments of the game interaction device provided below may be understood with reference to the limitations of the game interaction method above and will not be repeated here.

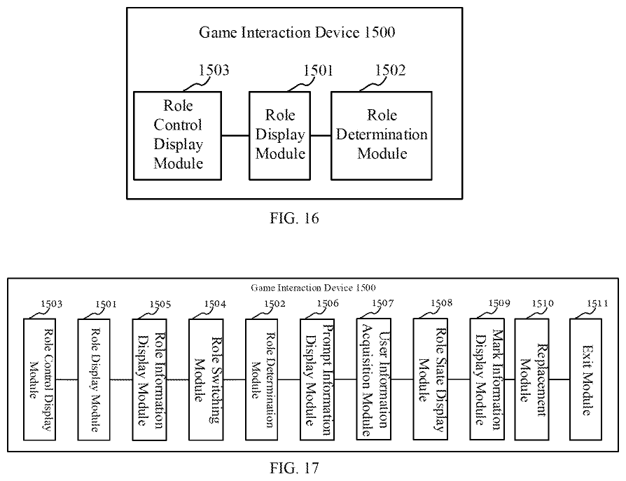

In an embodiment, as shown in FIG. 15, a game interaction device is provided. The game interaction device includes a role display module 1501 and a role determination module 1502.

The role display module 1501 is configured to display a virtual scene on a client device, and display, in response to a role display operation of a current user performed on the virtual scene, a role display interface in the virtual scene. One or more role virtual objects are displayed in the role display interface.

The role determination module 1502 is configured to acquire a role selection operation based on the role display interface, and determine, in response to the role selection operation, a corresponding role virtual object as a target role.

In an embodiment, as shown in FIG. 16, the device further includes a role control display module 1503. The role control display module 1503 is configured to display, in response to a first trigger operation on the virtual scene, at least one role control in the virtual scene before the role display module 1501 runs. The role display module 1501 is specifically configured to display, in response to the role display operation on the role control in the virtual scene, the role display interface in the virtual scene.

In an embodiment, referring to FIG. 17, in a case that one role virtual object and role information of the role virtual object are displayed in the role display interface, the device further includes a role switching module 1504. The role switching module 1504 is configured to display, in response to a second trigger operation on the role display interface, another role virtual object and role information of the another role virtual object in the role display interface.

In an embodiment, the role display interface further includes a role control list. The role switching module 1504 is configured to display, in response to a third trigger operation on the role control in the role control list, the role virtual object corresponding to the role control and the role information of the role virtual object corresponding to the role control in the role display interface.

In an embodiment, referring to FIG. 17, in a case that a plurality of role virtual objects are displayed in the role display interface, the device further includes a role information display module 1505. The role information display module 1505 is configured to display, in response to a fourth trigger operation on the role virtual object, the role information of the role virtual objects in the role display interface.

In an embodiment, referring to FIG. 17, the device further includes a prompt information display module 1506. The prompt information display module 1506 is configured to display, in a case that the role virtual object has been selected by another user, a prompt information in the role display interface. The prompt information is configured to indicate that the role virtual object has been selected. The prompt information display module 1506 is configured to display, in a case that the role virtual object is selected by the current user, a deselection control in the role display interface. The deselection control is configured to deselect the role virtual object.

In an embodiment, the role display interface further includes a role state list. The role state list includes current states of all of the role virtual objects.

In an embodiment, referring to FIG. 17, the role state list includes a role identifier corresponding to each of the role virtual objects and a state bar corresponding to each of role identifier. The device further includes a user information acquisition module 1507 and a role sate display module 1508. The user information acquisition module 1507 is configured to acquire user information of the role virtual object corresponding to each of the role identifier. The role sate display module 1508 is configured to display the user information of the role virtual object corresponding to the role identifier in the state bar corresponding to the role identifier.

In an embodiment, referring to FIG. 17, the device further includes a mark information display module 1509. The mark information display module 1509 is configured to display mark information corresponding to the role virtual object in the role state list.

In an embodiment, the role display interface further includes a user state list. The user state list includes the total number of users, the number of users who have selected the role virtual objects, and a role selection state of each of the users.

In an embodiment, the role display interface further includes a random selection control. The role determination module 1502 is further configured to randomly determine, in response to a fifth trigger operation on the random selection control in the role display interface, a role virtual object as the target role from all of unselected role virtual objects.

In an embodiment, referring to FIG. 17, the device further includes a replacement module 1510. The replacement module 1510 is configured to replace, when the random selection control is triggered, the random selection control with a cancel automatic assignment control. The cancel automatic assignment control is configured to deselect the target role.

In an embodiment, the role determination module 1502 is specifically configured to randomly determine, in response to the fifth trigger operation on the random selection control in the role display interface, and when a preset time period is reached, the role virtual object as the target role from all of the unselected role virtual objects.

In an embodiment, referring to FIG. 17, the device further includes an exit module 1511. The exit module 1511 is configured to exit to the virtual scene when a preset exit condition is satisfied.

In an embodiment, the preset exit condition includes any one of the following: all of the users corresponding to the virtual scene have completed the role selection; a preset role selection time period has been reached; and a sixth trigger operation based on a completion control in the role display interface has been detected.

The individual modules in the above game interaction device can be implemented in whole or in part by software, hardware and combinations thereof. Each of the above modules may be embedded in hardware form or independent of a processor in a computer device, or may be stored in software form on a memory in the computer device so that the processor can be called to perform the operations corresponding to each of the above modules.

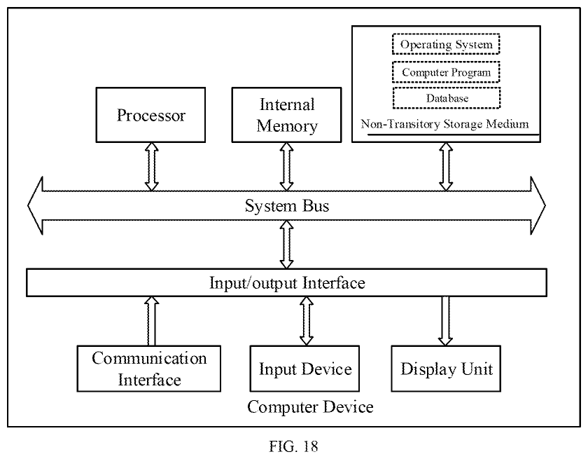

In an embodiment, a computer device is provided, which may be the client device. A diagram illustrating an internal configuration of the computer device may be shown in FIG. 18. The computer device includes a processor, a memory, a communication interface, a display unit, and an input device connected via a system bus. The processor of the computer device is configured to provide computing and control capabilities. The memory of the computer device includes a non-transitory storage medium and an internal memory. The non-transitory storage medium stores operating systems and computer programs. The internal memory provides an environment for the operation of operating systems and computer programs in non-transitory storage medium. The communication interface of the computer device is configured to communicate with other external client devices, gateways, mobile base stations and other communication nodes in wired or wireless mode, which can be realized by WIFI, mobile cellular network, near field communication (NFC) or other technologies. The computer programs are executed by the processor in order to implement a game interaction method. The display unit of the computer device can be an LCD or e-ink display, and the input device of the computer device can be a touch layer covering the display screen, i.e., a touch screen that combines the input device and the display unit into a single unit with both display and input functions. The input device can also be a key, trackball or trackpad set on the housing of the computer device, or an external keyboard, trackpad or mouse, etc.

It will be understood by those skilled in the art that the configuration illustrated in FIG. 18 is only a block diagram of a portion of the configuration associated with the solution of the present disclosure, and does not constitute a limitation of the computer device to which the solution of the present disclosure is applied. A specific computer device may include more or fewer components than shown in the figures, or may combine certain components, or have a different arrangement of components.

In this embodiment, the computer device includes a processor and a memory storing computer programs. The processor, when executing the computer programs, implements steps of the game interaction method in the above embodiments.

In an embodiment, a computer-readable storage medium is provided. The computer-readable storage medium has computer programs stored therein. The computer programs, when executed by a processor, implements steps of the game interaction method in the above embodiments.

In an embodiment, a computer program product is provided. The computer program product includes computer programs. The computer programs, when executed by a processor, implements steps of the game interaction method in the above embodiments.

It should be noted that the user information (including but not limited to user device information, user personal information, etc.) and data (including but not limited to data used for analysis, stored data, displayed data, etc.) involved in the present disclosure are information and data authorized by the user or fully authorized by all parties.

A person of ordinary skill in the art can understand that implementation of all or part of the processes in the methods of the above embodiments can be completed by instructing the relevant hardware through a computer program. The computer program may be stored in a non-transitory computer-readable storage medium. When the computer program is executed, it may include the processes of the embodiments of the above methods. Any reference to memory, database or other medium used of the embodiments provided in the present disclosure may include at least one of a non-transitory and a volatile memory. The non-transitory memory may include a read-only memory (ROM), a magnetic tape, a floppy disk, a flash memory, an optical memory, a high-density embedded non-volatile memory, a resistive random-access memory (ReRAM), a magnetoresistive random access memory (MRAM), a ferroelectric random-access memory (FRAM), a phase change memory (PCM), or a graphene memory, etc. The volatile memory may include a random-access memory (RAM) or an external cache memory, etc. As an illustration rather than a limitation, the random-access memory may be in various forms, such as a static random-access memory (SRAM) or a dynamic random-access memory (DRAM), etc. The databases involved of the embodiments provided by the present disclosure may include at least one of a relational database and a non-relational database. The non-relational database can include, without limitation, a blockchain-based distributed database, etc. The processor involved of the embodiments provided by the present disclosure may be a general-purpose processor, a central processor, a graphics processor, a digital signal processor, a programmable logic device, a data processing logic device based on quantum computation, and the like, without limitation.

The technical features in the above embodiments can be combined arbitrarily. For concise description, not all possible combinations of the technical features in the above embodiments are described. However, all the combinations of the technical features are to be considered as falling within the scope described in this specification provided that they do not conflict with each other.

The above-mentioned embodiments only describe several implementations of the present disclosure, and their description is specific and detailed, but should not be understood as a limitation on the patent scope of the present disclosure. It should be pointed out that for those skilled in the art may further make variations and improvements without departing from the conception of the present disclosure, and these all fall within the protection scope of the present disclosure. Therefore, the protection scope of the present disclosure should be subject to the appended claims.

1. A game interaction method, comprising:
displaying a virtual scene on a client device, and displaying, in response to a role display operation performed by a current user on the virtual scene, a role display interface in the virtual scene, one or more role virtual objects being displayed in the role display interface; and
acquiring a role selection operation based on the role display interface, and determining, in response to the role selection operation, a corresponding role virtual object as a target role.

2. The method of claim 1, wherein before the displaying, in response to the role display operation performed by a current user on the virtual scene, the role display interface in the virtual scene, the method further comprises:
displaying, in response to a first trigger operation on the virtual scene, at least one role control in the virtual scene; and
the displaying, in response to the role display operation performed by a current user on the virtual scene, the role display interface in the virtual scene comprising:
displaying, in response to the role display operation on the at least one role control in the virtual scene, the role display interface in the virtual scene.

3. The method of claim 1, wherein one role virtual object and role information of the role virtual object are displayed in the role display interface, and the method further comprises:
displaying, in response to a second trigger operation on the role display interface, another role virtual object and role information of the another role virtual object in the role display interface.

4. The method of claim 3, wherein the role display interface further comprises a role control list, and the method further comprises:
displaying, in response to a third trigger operation on the role control in the role control list, the role virtual object corresponding to the role control and the role information of the role virtual object corresponding to the role control in the role display interface.

5. The method of claim 1, wherein a plurality of role virtual objects are displayed in the role display interface, and the method further comprises:
displaying, in response to a fourth trigger operation on the role virtual object, the role information of the role virtual objects in the role display interface.

6. The method of claim 1, further comprising:
displaying, if the role virtual object has been selected by another user, a prompt information in the role display interface, the prompt information being configured to indicate that the role virtual object has been selected; and
displaying, if the role virtual object is selected by the current user, a deselection control in the role display interface, the deselection control being configured to deselect the role virtual object.

7. The method of claim 1, wherein the role display interface further comprises a role state list, the role state list comprising current states of all of the role virtual objects.

8. The method of claim 7, wherein the role state list comprises a role identifier corresponding to each of the role virtual objects and a state bar corresponding to each of role identifier, and the method further comprises:
acquiring user information of the role virtual object corresponding to each of the role identifier; and
displaying the user information of the role virtual object corresponding to the role identifier in the state bar corresponding to the role identifier.

9. The method of claim 7, further comprising:
displaying mark information corresponding to the role virtual object in the role state list.

10. The method of claim 1, wherein the role display interface further comprises a user state list, the user state list comprising the total number of users, the number of users who have selected the role virtual objects, and a role selection state of each of the users.

11. The method of claim 1, wherein the role display interface further comprises a random selection control;
the acquiring the role selection operation based on the role display interface and determining, in response to the role selection operation, the corresponding role virtual object as the target role comprising: randomly determining, in response to a fifth trigger operation on the random selection control in the role display interface, a role virtual object as the target role from all of unselected role virtual objects.

12. The method of claim 11, further comprising:
replacing, after the random selection control is triggered, the random selection control with a cancel automatic assignment control, the cancel automatic assignment control being configured to deselect the target role.

13. The method of claim 11, wherein the randomly determining, in response to the fifth trigger operation on the random selection control in the role display interface, the role virtual object as the target role from all of the unselected role virtual objects comprises:
randomly determining, in response to the fifth trigger operation on the random selection control in the role display interface, the role virtual object as the target role from all of the unselected role virtual objects when a preset time period is reached.

14. The method of claim 1, further comprising:
exiting to the virtual scene when a preset exit condition is satisfied.

15. The method of claim 14, wherein the preset exit condition comprises any one of the following:
all of the users corresponding to the virtual scene have completed the role selection;
a preset role selection time period has been reached; or
a sixth trigger operation based on a completion control in the role display interface has been detected.

16. A computer device, comprising a processor and a memory storing computer programs, wherein the processor, when executing the computer programs, implements steps of the method of claim 1.

17. A computer-readable storage medium, having computer programs stored therein, wherein the computer programs, when executed by a processor, implements steps of the method of claim 1.

18. A computer program product comprising computer programs, wherein the computer programs, when executed by a processor, implements steps of the method of claim 1.
